(19) United States
(12) Patent Application Publication
(10) Pub. No.: US 2010/0147565 A1
(43) Pub. Date: Jun. 17, 2010

(54) WINDOW BALL GRID ARRAY SUBSTRATE AND ITS PACKAGE STRUCTURE

(76) Inventors: Wen-Jeng Fan, Hukou (TW); Ching-Wei Hung, Hukou (TW); Tsai-Chuan Yu, Hukou (TW)

Correspondence Address: Muncy, Geissler, Olds & Lowe, PLLC, 4000 Legato Road, Suite 310, FAIRFAX, VA, 22033, US

(21) Appl. No.: 12/333,746

(22) Filed: Dec. 12, 2008

(51) Int. Cl. H01R 12/36

(52) U.S. Cl. 174/255

(57) ABSTRACT

A window ball grid array substrate and its package structure includes a package substrate with a long slot arranged thereon, wherein the improvement is characterized by the long slot penetrating an end of the package substrate making the package substrate appear to be U-shaped.

### BACKGROUND OF THE INVENTION

1. Field of the Invention

The present invention relates to a packaging technology, particularly a window ball grid array (wBGA) substrate and its package structure.

2. Description of the Related Art

In order for electronic product design to achieve being light, slim, short, and small, semiconductor packaging technology has kept progressing, in attempt to develop products that are smaller in volume, lighter in weight, higher in integration, and more competitive in market. As a result, chip size is often fairly close to its package size, while the number of designed bond pads is ever increasing.

In window ball grid array package technology, as shown in FIG. 1, because a chip bond pad is designed to be more and more close to edges of a package substrate 100, a slot 110 on a package substrate 100 must also be very close to edges, to provide enough room for wire bonding. The longer the slot 110, the narrower the connecting portions on edges of a package substrate, which may cause problems in punching procedure for manufacturing the substrate. In prior art, the whole package substrate is penetrated through and separated into two pieces. However, this may accompany low yield, low accuracy for punching and tooling wearing issues.

### SUMMARY OF THE INVENTION

One objective of the present invention is to provide a window ball grid array substrate and its package structure, wherein one side of a package substrate is penetrated through by a long slot, making it appear to be U-shaped.

One objective of the present invention is to provide a window ball grid array substrate and its package structure, wherein a U-shaped package substrate can allow enough room for wire bonding.

To achieve the abovementioned objectives, one embodiment of the present invention discloses a window ball grid array substrate including a substrate, with a plurality of package substrates arranged thereon in array and a plurality of long slots arranged on each of the package substrates respectively, with one side of each long slot exceeding the package substrate, making each package substrate appear to be U-shaped.

Another embodiment of the present invention discloses a window ball grid array substrate including a substrate, with a plurality of package substrates arranged thereon in array, and a plurality of long slots, each extending across two adjacent package substrates, wherein each package substrate appears to be U-shaped.

Still another embodiment of the present invention discloses a window ball grid array substrate including a long slot arranged on a package substrate, which is characterized by said long slot penetrating through one side of said package substrate, making said package substrate appear to be U-shaped.

One embodiment of the present invention discloses a window ball grid array package structure including a package substrate with a long slot arranged thereon, wherein the long slot penetrates one side of the package substrate and makes the package substrate appear to be U-shaped; a chip arranged on the upper surface of the package substrate, a plurality of wires electrically connecting the chip with the lower surface of the package substrate through the long slot, a package material filling the long slot completely and encapsulating the chip and wires on the upper and lower surface of the package substrate respectively, and a plurality of conducting ball arranged on the lower surface of the package substrate.

### BRIEF DESCRIPTION OF THE DRAWINGS

FIG. 1 is a schematic diagram of a top-view of a conventional window ball grid array substrate;

FIG. 2 is a diagram schematically showing a top-view of a window ball grid array substrate according to one embodiment of the present invention.

FIG. 3 is a diagram schematically showing a top-view of a window ball grid array substrate according to another embodiment of present invention.

FIG. 4 is a diagram schematically showing a top-view of a window ball grid array substrate according to one embodiment of the present invention.

FIG. 5 is a diagram schematically showing a cross sectional-view of a window ball grid array substrate package structure according to one embodiment of the present invention.

FIG. 6A to FIG. 6B are diagrams schematically showing two side-views of a window ball grid array substrate package structure according to one embodiment of the present invention.

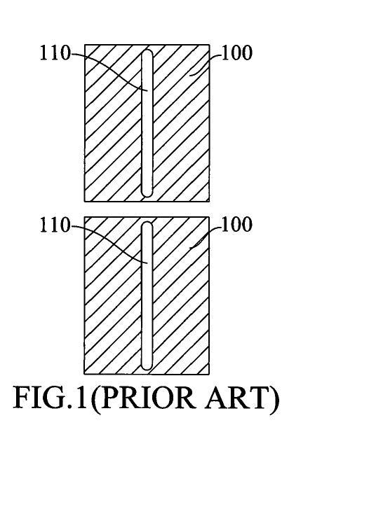

### DETAILED DESCRIPTION OF THE INVENTION

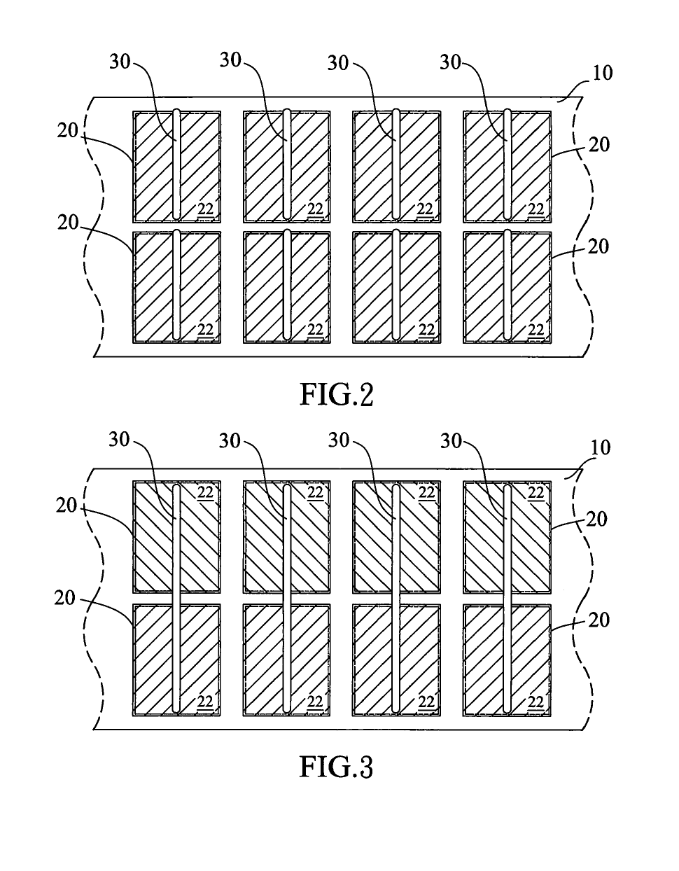

Referring to FIG. 2, FIG. 2 is a schematic diagram of a preferred embodiment of the present invention. In this embodiment, the window ball grid array substrate includes a substrate 10 with a plurality of package substrates 20 arranged thereon in array, and a plurality of long slots 30 arranged on each package substrate 20 respectively. Each of the package substrates 20 includes a chip-attaching area 22. The chip-attaching area 22 is slightly smaller than the package substrate 20 in size.

In continuation of the above illustration of this preferred embodiment, one side of each long slot 30 exceeds the corresponding package substrate 20, which makes each of the package substrates 20 appearing to be U-shaped. The other side of each long slot 30 is close to an edge of its package substrate 20. As shown in FIG. 2, when a chip (not shown in the figure) is arranged on a chip-attaching area 22, a long slot 30 exceeding one side of the chip-attaching area 22 can increase the locations for bond pad design and space for wire bonding. In this preferred embodiment, keeping enough distance between the U-shaped opening of a package substrate 20 and the U-shaped opening of the neighboring package substrate 20 allows the long slot 30 to have enough operating space to maintain good manufacturing yield.

Referring to FIG. 3, in another preferred embodiment, each of long slots 30 extends across any two adjacent package substrates 20, making each package substrate 20 appearing to be U-shaped, wherein both sides of a long slot 30 are close to the edges of package substrates 20 respectively. Furthermore, a long slot 30 can be arranged across any two adjacent package substrates 20 in the same column or in the same row.

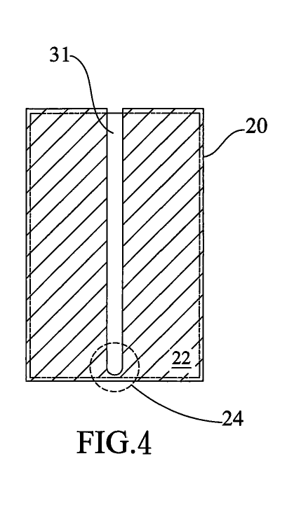

As shown in FIG. 4, a window ball grid array substrate includes a long slot 31 arranged on a package substrate 20 in one embodiment. The long slot 31 exceeds one side of the package substrate 20 making it appear to be U-shaped. One side of long slot 31 is close to an edge 24 of the package substrate 20.

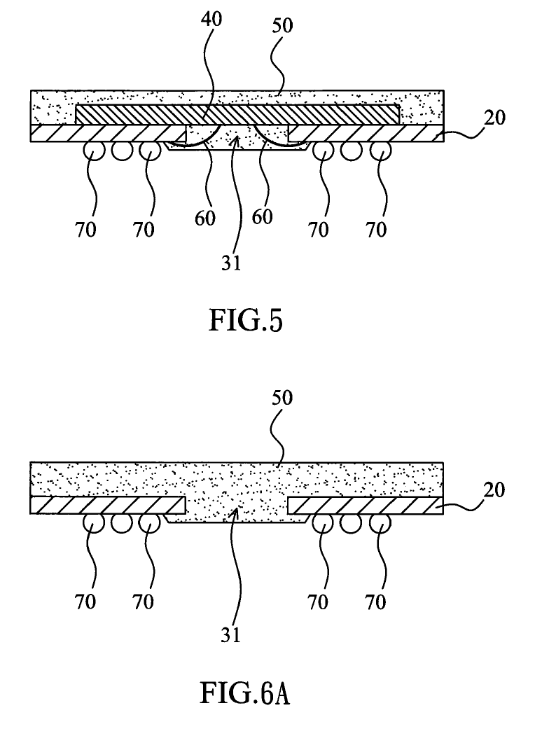

Please referring to both FIG. 4 and FIG. 5, in one embodiment, a window ball grid array package structure constructed by utilizing a package substrate 20 includes a package substrate 20, at least a single chip 40, a plurality of wires 60, a package material 50 and a plurality of conducting balls 70.

In continuation of the above illustration, as shown in FIG. 5, a long slot 31 is arranged on the package substrate 20. The long slot 31 exceeds one side of the package substrate 20 making the package substrate 20 appear to be U-shaped, as shown in FIG. 4. The chip 40 is arranged on the upper surface of the package substrate 20. Wires 60 electrically connect the chip 40 and the lower surface of the package substrate 20 through the long slot 31. The package material 50 fills the long slot 31 completely and encapsulates the chip 40 on the upper surface of the package substrate 20 and the wires on the lower surface of the package substrate 20. A plurality of conducting balls 70 are arranged on the lower surface of the package substrate 20.

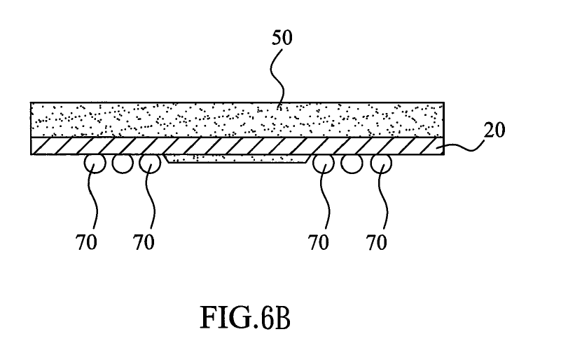

In this embodiment, owing to the package substrate 20 appearing to be U-shaped, in a window ball grid array package structure, one side of the package substrate 20 is an open-end as shown in FIG. 6A, and the other side of the package substrate 20 is a close-end as shown in FIG. 6B.

In conclusion, the present invention provides U-shaped package substrates for window ball grid array packaging. When a slot is arranged on a package substrate, it can not only increase space for bond pad design and wire bonding, but also can maintain good yield and high accuracy for punching. A U-shaped package substrate structure can also be acquired when a slot is arranged on two package substrates.

The embodiments described above are to demonstrate the technical contents and characteristics of the preset invention to enable the persons skilled in the art to understand, make, and use the present invention. However, it is not intended to limit the scope of the present invention. Therefore, any equivalent modification or variation according to the spirit of the present invention is to be also included within the scope of the present invention.

What is claimed is:

1. A window ball grid array substrate comprising:
a substrate having a plurality of package substrates arranged thereon in array; and
a plurality of long slots arranged on each of said package substrates respectively, wherein one side of each said long slot exceeds said package substrates, so that each of said package substrates appears to be U-shaped.

2. The window ball grid array substrate according to claim 1, wherein the other side of each said long slot is close to an edge of said package substrate.

3. A window ball grid array substrate comprising:
a substrate comprising a plurality of package substrates arranged thereon in array; and
a plurality of long slots, wherein each of said long slots extends across any two adjacent package substrates, and each of said package substrates appears to be U-shaped.

4. The window ball grid array substrate according to claim 3, wherein each of said long slots is arranged on any of two package substrates adjacent in the same column.

5. The window ball grid array substrate according to claim 3, wherein each of said long slots is arranged on any of two package substrates adjacent in the same row.

6. The window ball grid array substrate according to claim 3, wherein the both sides of each of said long slots are close to edges of said package substrates.

7. A window ball grid array substrate comprising a long slot arranged on a package substrate, wherein said long slot penetrates one side of said package substrate and makes said package substrate U-shaped.

8. A window ball grid array package structure comprising:
a package substrate with a long slot arranged thereon, wherein said long slot penetrates one side of said package substrate and makes said package substrate appear to be U-shaped;
a chip arranged on the upper surface of said package substrate;
a plurality of wires electrically connecting said chip and the lower surface of said package substrate through said long slot;
a package material filling completely said long slots and encapsulating said chip on the upper surface of said package substrate and said wires on the lower surface of said package; and
a plurality of conducting balls arranged on the lower surface of said package substrate.
